(19) United States
(12) Patent Application Publication
(10) Pub. No.: US 2008/0101662 A1
(43) Pub. Date: May 1, 2008

(54) PRINT MATCHING METHOD AND APPARATUS USING PSEUDO-RIDGES

(75) Inventors: PETER Z. LO, LAKE FOREST, CA (US); YING LUO, IRVINE, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/554,720

(22) Filed: Oct. 31, 2006

(51) Int. Cl. G06K 9/00

(52) U.S. Cl. 382/124

(57) ABSTRACT

A method for comparing a search print image comprising a first plurality of minutiae to a file print image comprising a second plurality of minutiae and the apparatus implementing the method is provided. The method includes the steps of: aligning the search and file print images; obtaining the first and second plurality of minutiae, a first plurality of pseudo-ridges generated from a first direction field of the search print image and a second plurality of pseudo-ridges generated from a second direction field of the file print image; for each aligning of the search and file print images, generating a pseudo-ridge score, and determining a minutiae matching score; and providing, based on the pseudo-ridge and minutiae matching scores, an output that indicates a level of similarity between the search and file print images.

### TECHNICAL FIELD

The present invention relates generally to print matching and more particularly to comparing print images, such as fingerprint images, using pseudo-ridges generated from corresponding directions fields of the print images.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, are extracted. The personal information and the extracted features are then used to form a file record that is saved into a database for subsequent print identification. Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Many solutions have been proposed to improve the accuracy of similarity scores and to reduce the workload of manual examiners. These methods include: designing improved fingerprint scanners to obtain better quality print images; improving feature extraction algorithms to obtain better matching features or different features with more discriminating power; and designing different types of matching algorithm from pattern based matching to minutiae and texture based matching, to determine a level of similarity between two prints.

One type of feature that can be extracted from a print image is called a pseudo-ridge. At present pseudo-ridges have been used to verify classification of a print (during image pre-processing) into one of N types such, for instance, arch, left loop, right whorl, etc. However, there are no known matching algorithms that use pseudo-ridge information to determine a level of similarity between two prints, even though pseudo-ridges contain enough detail to be useful in matching algorithms.

Thus, there exists a need for a method and apparatus for comparing two print images using, among other features, respective pseudo-ridges from the print images and generating a resultant indication of similarity between the two print images.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an AFIS implementing embodiments of the present invention.

FIG. 2 illustrates core and delta singularity points on a print image, the detection of which can be enhanced using embodiments of the present invention.

FIG. 3 illustrates a direction field for a print image, the generation of which can be enhanced using embodiments of the present invention.

FIG. 4 is a flow diagram illustrating a method for print image feature extraction in accordance with an embodiment of the present invention.

FIG. 5 illustrates pseudo-ridge feature extraction for a plain arch type fingerprint in accordance with an embodiment of the present invention.

FIG. 6 illustrates pseudo-ridge feature extraction for up-core and below a core in accordance with an embodiment of the present invention.

FIG. 7 is a flow diagram illustrating a method for comparing a search and file print image using pseudo-ridge features, in accordance with an embodiment of the present invention.

FIG. 8 is a flow diagram illustrating a method for comparing a search and file print image using pseudo-ridge features, in accordance with an embodiment of the present invention.

FIG. 9 illustrates the calculation of a pseudo-ridge score during the print matching process, in accordance with an embodiment of the present invention.

### DETAILED DESCRIPTION

Before describing in detail embodiments that are in accordance with the present invention, it should be observed that the embodiments reside primarily in combinations of method steps and apparatus components related to a method and apparatus for print matching using pseudo-ridges. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for print matching using pseudo-ridges described herein. The non-processor circuits may include, but are not limited to, a radio receiver, a radio transmitter and user input devices. As such, these functions may be interpreted as steps of a method to perform the print matching using pseudo-ridges described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device“ for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device and a magnetic storage device. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, pseudo-ridge features are used to enhance the print matching process. Those skilled in the art will realize that any advantages described herein are merely exemplary and are not meant to be a complete rendering of all of the advantages of the various embodiments of the present invention.

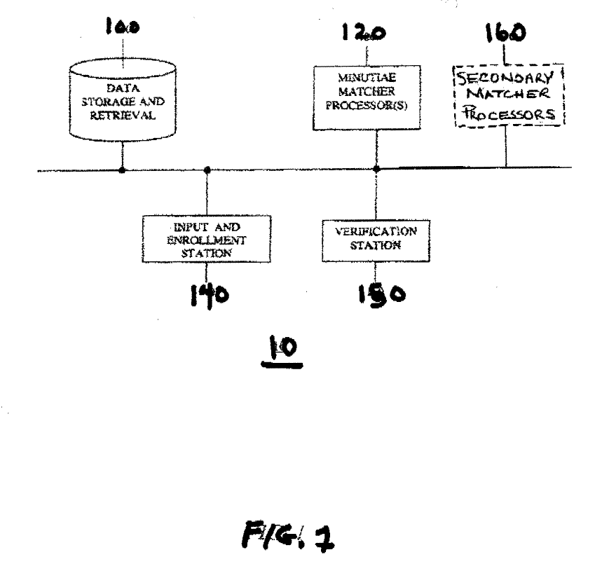

Referring now to the drawings, and in particular FIG. 1, a logical block diagram of an exemplary fingerprint matching system implementing embodiments of the present invention is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identifies one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to herein as respondent file print images).

Before describing system 100 in detail, it will be useful to define terms that are used herein.

A print is a pattern of friction ridges (also referred to herein as “ridges”), which are raised portions of skin, and valleys between the ridges on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range. An example of a range of gray-level values is 0 to 255.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeable with the term score) that identifies or indicates similarity of a file print to a search print based on one or more given parameters.

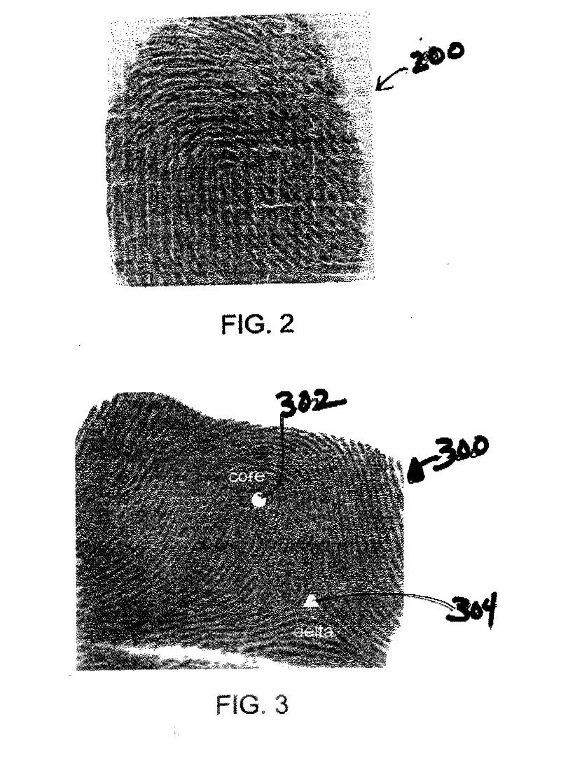

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. FIG. 2 illustrates a direction image 200 of a fingerprint.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum. FIG. 3 illustrates a core singularity point 302 on a fingerprint image 300.

According to ANSI-INCITS-378-2004 standard, a delta is the point on a ridge at or nearest to the point of divergence of two type lines, and located at or directly in front of the point of divergence. FIG. 3 further illustrates a delta singularity point 304 on the fingerprint image 300.

A classification feature is a feature used during print image pre-processing to classify a print into one of N types. Examples of classification features include, but are not limited to, arch (e.g., tented arch, plain arch), whorl, loop (e.g., left loop, right loop), etc.

Global features include, at a minimum, singularity points and classification features.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160.

The input and enrollment station 140 is implemented using one or more suitable processing device, examples of which are listed above, and is used to capture fingerprint images and to extract the relevant features (minutiae, cores, deltas, the direction image, pseudo-ridges, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150. Embodiments of the present invention may be implemented in the minutiae and/or secondary matcher processors, which in turn can be implemented using one or more suitable processing devices, examples of which are listed above.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

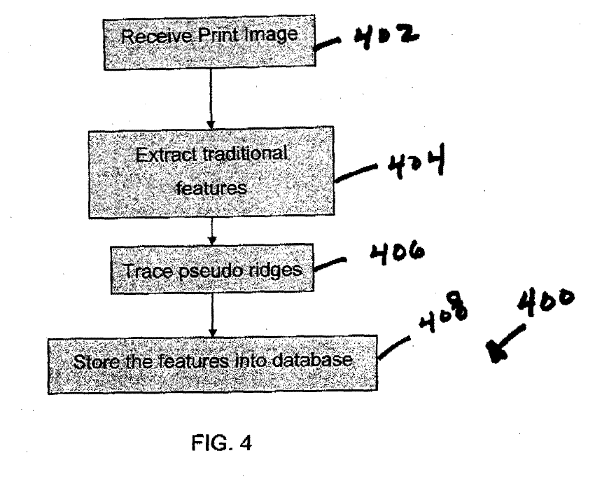

Turning now to FIG. 4, a flow diagram illustrating an exemplary method of feature extraction from a print image in accordance with an embodiment of the present invention is shown and generally indicated at 400. Method 400 (as well as the other methods below illustrating additional embodiments) is described in terms of a fingerprint identification process (such as one implemented in the AFIS shown in FIG. 1), for ease of illustration. However, it is appreciated that the method may be similarly implemented in biometric image enrollment for other types of prints such as, for instance, palm prints or toe prints without loss of generality. Thus, these other types of prints and images are contemplated within the meaning of the terms “print” and “fingerprint” as used in the various teachings described herein.

Fingerprint images are received (step 402) into the AFIS via any suitable interface. For example, the fingerprint images can be captured from someone's finger using a sensor coupled to the AFIS or the fingerprint image could have been scanned into the AFIS from a ten-print card, for example, used by a law enforcement agency. The fingerprint images are stored electronically in the data storage and retrieval unit 100. Moreover, the impression type or method (e.g., roll, slap, etc.) and finger number (e.g. 1-10 moving from left to right from the pinky on the left hand to the pinky on the right hand) may be stored with the fingerprint image. The remaining steps are implemented using a suitable processing device, examples of which are given above.

At step 404 “traditional” features, i.e., features other than pseudo-ridges are extracted or generated for each fingerprint image. For example, a direction field is generated based on the fingerprint image and cores and deltas (if any) are detected from the direction field. In one embodiment, the estimation of direction image and core/delta detection are performed through an iterative hierarchical method. Using this method, the direction image is smoothed with the detected core/delta as a reference. After the direction image is smoothed, the core/delta are detected again and the information is fed back to direction image smoothing. This procedure is iteratively executed until the direction image is sufficiently smooth based on a predetermined direction image consistency metric. However, the teachings herein are not limited to the optimized direction image construction and core/delta detection described above. Other traditional methods can be used such as those implementing fixed-window smoothing. Using the direction image to enhance the image with Gabor filter, for example, minutiae are extracted from the fingerprint image after binarization and thinning. Additional traditional features associated with each finger print image are further determined, such as, classification type, e.g., whorl, left loop, right loop, tented arch, plain arch

At step 406, a plurality of pseudo-ridges are traced for each fingerprint image. In general, a pseudo-ridge is traced along each minutiae's direction and opposite direction, and sample points are taken at fixed intervals along the pseudo-ridge. Features, including direction, curvature and quality at the traced pseudo-ridge sample points are stored along with the traditional features at step 408. The sample points for the pseudo-ridge may be based on a single pixel but are usually based on blocks of pixels in the direction image, with each block being assigned a direction (referred to herein as a direction measure) obtained through majority voting. The tracing of additional pseudo-ridges can begin on the border of the fingerprint area and continued until it hits the border again or it comes back to its original starting location. Repeating pseudo-ridges starting from different border blocks are found and eliminated. Moreover, other starting points for pseudo-ridge tracing can be used depending on factors including, but not limited to, the classification of the fingerprint, image quality in a given area of the direction image, whether the direction image contains one or more cores or deltas, etc.

For example, for a direction image that corresponds to a fingerprint that is classified as a plain arch type, an exemplary technique for extracting pseudo-ridges is next discussed. A plain arch is formed by ridges entering one side of the print and exiting another side. These ridges tend to rise in the center of the fingerprint pattern forming a wave-like pattern. A tented arch is similar to the plain arch except that instead of rising smoothly in the center, there is a sharp upthrust or spike or the ridges meet at an angle of less than ninety degrees. Regarding the specifics of extracting pseudo-ridges and associated features for a plain arch type print, an initial starting point is selected that can be, for example, the geometric center of the arch on the direction image, which can be found by calculating the geometric mean of all the fingerprint points' x and y coordinates. If the quality of this point is above certain quality threshold, keep it as the starting point and begin tracing the pseudo-ridge. Otherwise, find the geometrical center of the minutiae set, and if the quality of this point is above the quality threshold, use it as the starting to begin pseudo-ridge tracing. Otherwise, use the minutia with the highest quality as the starting point for pseudo-ridge tracing. It should be noted that if the highest quality minutiae is below the quality threshold, the pseudo-ridges (and in consequence a principle axis based on the pseudo-ridges as discussed below) cannot be reliably extracted, making pseudo-ridge matching for this print less reliable. However if the highest quality minutiae exceeds the quality threshold, keep this point as the starting point. The quality threshold is determined empirically based on the effectiveness of the pseudo-ridge method on plain arch print matching problem.

Once the starting point is chosen, since its quality is above the quality threshold a pseudo-ridge can be detected and traced. If after tracing the pseudo-ridge, if the two ends of this pseudo-ridge are within a predetermined distance of the fingerprint border (such as, for instance, within 24 pixels of the border), this pseudo-ridge is valid. If this distance to the border criterion is unmet, a new starting point is selected. For example, if the current starting point is the available highest-quality minutia, choose the next available highest quality minutia as the new starting point.

For a current valid pseudo-ridge, find the maximum curvature point and the normal direction at the maximum curvature point. Project a point up (down) the normal axis with K pixel interval, and if the quality of this point is above the quality threshold, use this point as the new starting point to trace another pseudo-ridge. Otherwise continue projecting at K/2×N+K intervals until another point is found with sufficient quality or the new point is out of the border of the fingerprint. For each traced pseudo-ridge that fails to meet the above distance from the border criterion, the pseudo-ridge is discarded, and another point is selected by continuing to project up (down) the normal axis at K/2×N+K intervals until we find another point with sufficient quality or the new point is out of the border of the fingerprint. The above steps of finding new starting points and tracing pseudo-ridges can be continued until the number of pseudo-ridges extracted meets a predetermined threshold depending, for example, on accuracy requirements or until all new starting points meeting the quality threshold have been detected.

For each valid pseudo-ridge in the arch fingerprint, the maximum curvature point on the pseudo-ridge is determined and fitted to a straight line by minimum square error (MSE), for example. This straight line is the principle axis of the fingerprint. Starting from the crossing-point of the principle axis and each pseudo-ridge, sample a point at every K points. Upon each sampling, check whether the sampled point is within certain range of any minutia. If it is, the point is still sampled but only its association with the current pseudo-ridge is recorded to maintain the pseudo-ridge information. Otherwise, the direction, curvature and quality of the sample are recorded.

If after the previous steps, the principle axis cannot be found or even if it is found, but the number of sampling point is not enough, a further step can be taken to determine the image areas with quality above the quality threshold and these areas evenly sampled. For each sample point, trace the pseudo-ridge associated with it in the “good-quality” area. If the maximum curvature of the traced pseudo-ridge is above some threshold determined by empirical values found by experiments, this pseudo-ridge is maintained and points sampled from this pseudo-ridge. Repeat this procedure of evenly-sampling until enough sample points are detected or the good quality area is exhausted. Moreover, if one sample point is close enough to an existing sample point, the point is sampled and features are the same as the existing one, and its association with the current pseudo-ridge is recorded to maintain the pseudo-ridge information as discussed above. At the end of this process, all of the minutiae (and other traditional features) and sample point features together with associated pseudo-ridge structure is stored as the feature set for this arch fingerprint image.

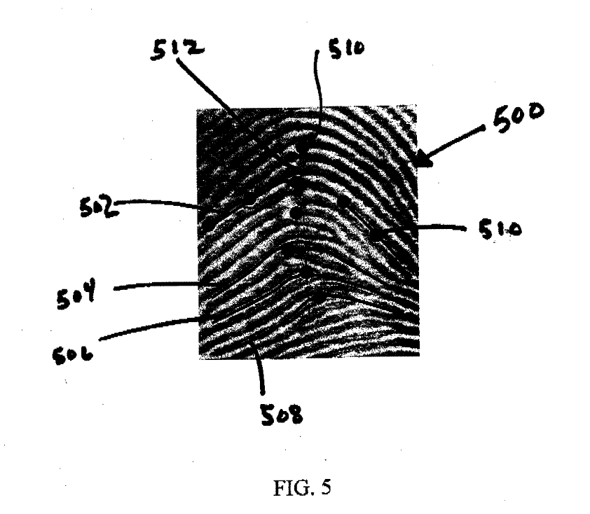

FIG. 5 illustrates a plain arch fingerprint image 500. Examples of traced pseudo-ridges (502, 504, 506, 508) are shown as darkened solid lines. Solid points (two of which are labeled 510) are the points on a pseudo-ridge with maximum curvature. Also, a principle axis 512 is shown, which was obtained by MSE fitting.

The following process for pseudo-ridge associated feature capture can be implemented for prints having detected core(s) and/or delta(s). If the fingerprint image contains one up core with zero or one low core and zero to two deltas, find a principle axis of the image, which is in the core direction. The starting point for the first pseudo-ridge is above the core location K pixels along the opposite of the core direction. Trace a pseudo-ridge from this starting point if the point meets the quality threshold.

From the current starting point, project a point up the principle axis using a K pixel interval, to find a new starting point. If the quality of this point is above the quality threshold, use this point as the new starting point and trace another pseudo-ridge. Otherwise continue to project at K/2×N+K intervals to find another point with sufficient quality or until the new point is outside of the border of the fingerprint image. If the newly-traced pseudo-ridge doesn't meet the distance to the border criterion (the same criterion used for the plain arch type fingerprint) discard the ridge and continue projecting at K/2×N+K intervals to find another point with sufficient quality or until the new point is outside of the border of the fingerprint image. The above steps of finding new starting points and tracing pseudo-ridges can be continued until the number of pseudo-ridges extracted meets a predetermined threshold or the number of starting points is exhausted.

Starting from the crossing-point of the principle axis and each pseudo-ridge, sample a point at every K points on the pseudo-ridge. Upon each sampling, determine whether the sampled point is within a predetermined range of any minutia. If it is, the point is still sampled but only its association with the current pseudo-ridge is recorded to maintain the pseudo-ridge information. Otherwise, the direction, curvature and quality of the sample are also recorded.

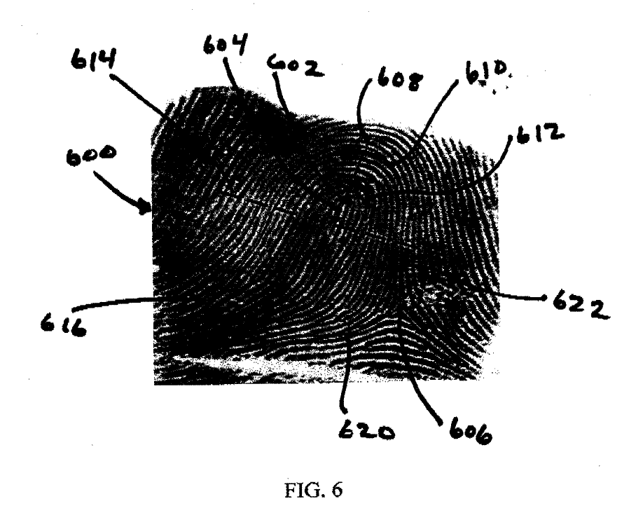

After tracing the pseudo-ridges above the up-core, trace the pseudo-ridges under the core. To do this, project a point K pixels down the principle axis from the core, and find the normal direction at this point. Project K×M points along both sides of the normal line, and trace the pseudo-ridges only along the core direction as shown in FIG. 6. FIG. 6 illustrates a fingerprint image 600 having a detected core 602 (with a direction as indicated by an arrowed line 604) and a detected delta 606. A principle axis is indicated by a dashed line 608. Two traced pseudo-ridges 610, 612 above the up-core are shown. A dashed line 614 indicates the normal line from which the starting points are determined for tracing pseudo-ridges under the core. Dark solid lines under line the normal 614 (three of which are labeled 616, 620, 622) indicated pseudo-ridges traced under the core 602.

The number of possible starting points, M, for tracing pseudo-ridges below the core is determined by the distance between the normal distance, D, between the principle axis and the delta if a delta exists and is calculated as: M=D/K×2. Thus, there are D/K ridges traced on each side of the principle axis. If there is no detected delta, M is determined by continuing to project points along line 614 until the maximum curvature on a traced pseudo-ridge is lower than a predetermined threshold or the closest distance between a pseudo-ridge starting point and the fingerprint border is lower than a predetermined threshold. Pseudo-ridge tracing below the core can be continued until the number of pseudo-ridges extracted meets a predetermined threshold or the number of starting points is exhausted. Moreover each pseudo-ridge traced under the core is sampled and features stored in a manner similar to that described above with respect to pseudo-ridges traced above the up-core.

If one or more deltas are detected on the fingerprint image, also trace the pseudo-ridge(s) for each delta. The procedure for delta pseudo-ridge tracing is as follows: for the three directions of delta, trace a pseudo-ridge along each direction until the distance to the fingerprint border criterion is met or until a point is reached whose quality is below the quality threshold. Furthermore, for each delta direction, project points opposite to the delta direction at every K pixels, and trace the pseudo-ridges at each of these points if the point is of sufficient quality and the maximum curvature on the pseudo-ridge is above the threshold. As with the other pseudo-ridges traced below the core, the traced pseudo-ridges associated with the delta point(s) are sampled and the corresponding features stored.

In the case where there is another low core (which indicates a whorl type fingerprint) similarly: find a principle axis of the image based on the low core's direction; trace the pseudo-ridges; sample them accordingly; and store the resultant features. The only difference in this particular case is that the starting points of the pseudo-ridge are projected downwards. If after performing the above steps for the fingerprint image with core(s) and delta(s) the number of sampling points is insufficient, the same procedure of evenly-sampling can be performed as was discussed above by reference to the plain arch fingerprint type. Moreover just as with the plain arch fingerprint type, at the end of the pseudo-ridge feature extraction process, all of the minutiae (and other traditional features) and sample point features together with associated pseudo-ridge structure is stored as the feature set for the fingerprint image.

The following additional conditions can exist in the fingerprint image, which require a modification of the pseudo-ridge feature extraction processed discussed above. For example, where the fingerprint image contains only one low core (as in some bad quality whorl class fingerprints for which the up core is not detected), trace only valid low core and delta pseudo-ridges in the manner described above. Where only deltas exist, trace their associated pseudo-ridges and, if necessary, the pseudo-ridges starting with the evenly-sampled points in the manner described above. If no registration points (e.g., no minutiae points, cores or deltas) are detected of sufficient quality, select good quality areas and obtain even samples and the associated pseudo-ridges and pseudo-ridge features.

Moreover, to save matching time, the above processes for extracting and storing pseudo-ridge features are performed in the pre-processing (registration) stage for file prints. However, the pseudo-ridges of search prints need not be pre-calculated. The direction field and curvature of search prints can be directly found at the corresponding location of file print, wherein the number of sample points used depends on the application and storage constraints. Since the neighborhood of fingerprints taken from the same person should have similar direction, the sampling of points on the search and file prints need not be to taken too closely. For example, K can be set to 30 pixels for both the search and file prints. Based on these guidelines the total number of sample points selected (and corresponding pseudo-ridge features determined) for the search print is usually about twice the number of minutiae points detected on the search print.

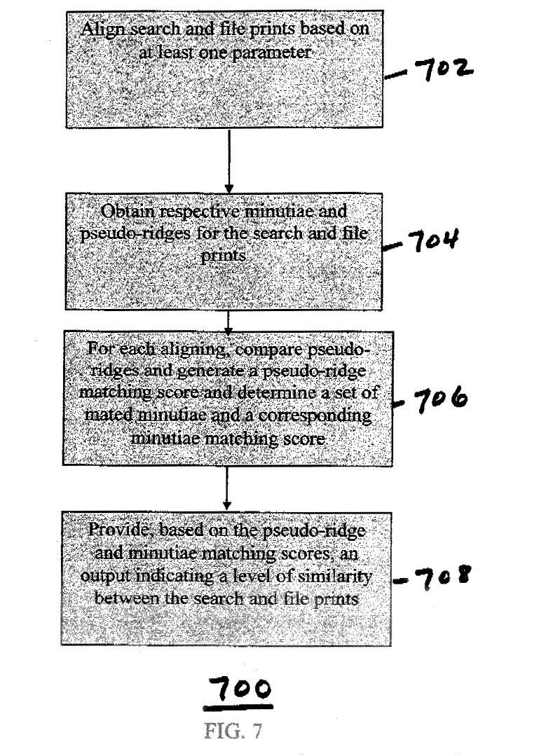

Next described are methods for fingerprint matching using pseudo-ridge features in accordance with embodiments of the present invention. Turning to FIG. 7, a high-level flow diagram of a method for comparing a search and file print image in accordance with the teachings herein is indicated generally at 700. The comparison is performed in a print matcher that is comparing search and file print images from respective search and file print records. The records (and images) being compared can be obtained as discussed above and the method 700 used to determine similarity between search and file print images.

Accordingly, method 700 comprises the steps of: aligning (702) the search and file print images based on at least one parameter, such as minutiae or global features; obtaining (704) the first and second plurality of minutiae, a first plurality of pseudo-ridges generated from a first direction field of the search print image and a second plurality of pseudo-ridges generated from a second direction field of the file print image; for each aligning of the search and file print images, comparing (706) the first and second plurality of pseudo-ridges and generating a pseudo-ridge score, and determining a set of mated minutiae between the first and second plurality of minutiae and a corresponding minutiae matching score; and providing (708), based on the pseudo-ridge and minutiae matching scores, an output that indicates a level of similarity between the search and file print images.

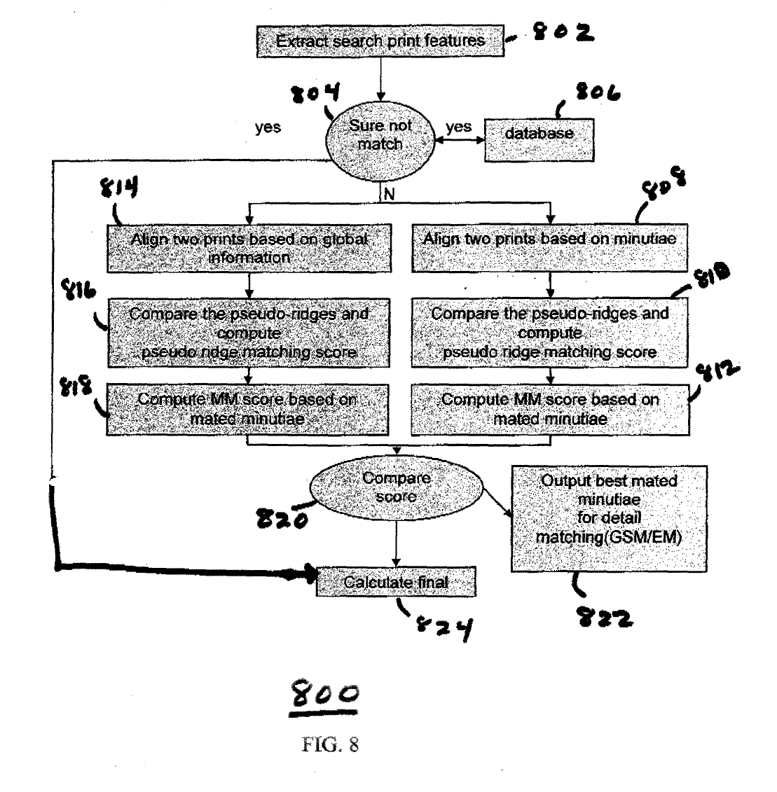

In FIG. 8, a flow diagram of a more detailed method 800 for implementing the steps of method 700 is shown. This method includes the beneficial implementation details that were briefly mentioned above. Moreover, method 800 is described in terms of a fingerprint identification process (such as one implemented in the AFIS shown in FIG. 1) for ease of illustration. However, it is appreciated that the method may be similarly implemented in biometric image comparison for other types of prints such as, for instance, palm prints or toe prints without loss of generality. Thus, these other types of prints and images are contemplated within the meaning of the terms “print” and “fingerprint” as used in the various teachings described herein.

An overview of method 800 will first be described, followed by a detailed explanation of an exemplary implementation of method 800 in an AFIS. In accordance with the above description, a search print is obtained and search print features (excluding the pseudo-ridge features) are extracted, at a step 802. The search print is compared (in the remaining steps) to a file print from a file record obtained from a database 806 (e.g., data storage and retrieval unit 100). An initial filter, for example based on classification type, is used (at a step 804) to determine whether further matching should be performed. Upon a positive determination that the prints do not match, i.e., a “sure not match” (because of e.g., different finger numbers, different classification or pattern types, etc.), a final matching score is determined at a step 824, and a new file print image is retrieved from the database 806. For example, if both prints are definitely different pattern types, the final score can be set to zero or some other score that indicates a sure not match. In another example, if both prints have corresponding core and delta points, but if the difference between the core-delta distances of the two prints is greater than a distance threshold, the final score can be set to zero or some other score that indicates a sure not match. The distance threshold can, for instance, be set to twice or one and half times the maximum possible location error tolerance for a detected core and delta.

Where the two prints could be a match, further matcher processing is performed in accordance with the remaining steps of method 800. In this exemplary embodiment, there are two matcher processing branches, a left branch and a right branch, which are based on two different alignments of the file and search print images. In the left processing branch, the file and search print images are aligned (at a step 814) based on global features including, but not limited to, cores, deltas, classification type associated with the two print images. Once aligned, the pseudo-ridges of the print image are compared (at a step 816) using the stored pseudo-ridge features and a pseudo-ridge matching score computed. In addition, mated minutiae between the two print images are determined based on the alignment and a minutiae matching score computed, at a step 818.

The right processing branch is similar to the left processing branch except that the search and file print images are aligned (at a step 808) based on respective minutiae extracted from the print images. Thereafter, the pseudo-ridges of the print images are compared (at a step 810) using the stored pseudo-ridge features and a pseudo-ridge matching score computed. In addition, mated minutiae between the two print images are determined based on the alignment and a minutiae matching score computed, at a step 812. The output of the left processing branch is one pseudo-ridge matching score and one minutiae matching score based on the global feature alignment of the search and file print images. The output of the right processing branch is one pseudo-ridge matching score and one minutiae matching score based on the minutiae-based alignment of the search and file print images.

These four scores are provided to a decision logic that compares the scores (at a step 820) to further provide an output that is indicative of a level of similarity between the search and file print images. For example, based on the decision logic, a set of mated minutiae representing a best or preferred set of mated minutiae may be provided to a secondary matcher, such as a Gray Scale Matcher (GSM) or an Expert Matcher (EM) (at a step 822) for use in its secondary matcher processing. Alternatively or in addition thereto, a final score based on the four scores can be output at step 824 to use, for instance, in providing a candidate list of highest ranking file records for manual examination.

Next described is a more detailed description of exemplary matcher processing in an AFIS system in accordance with the left and right branches, describing how the alignment and scoring steps can be implemented and further describing exemplary decision logic for comparing the four matching score and generating one or more resultant similarity measures. A first case discussed is where both fingerprint images are arch types.

To align the fingerprint images based on the global features (at step 814), rotate two fingerprint images so that they are both in a vertical direction according to the respective principle axis of both prints. Find maximum aligned minutiae pairs by shifting up and down the entire set of the search print's minutiae with respect to the file print's set of minutiae and comparing the respective sets of minutiae at every shifting step. This is the mated minutiae set. Two minutiae are considered mated, for example, if their angles and transformed location are within a predetermined tolerance determined based on experiments.

To prepare for comparing the pseudo-ridges of the search and file prints compare the non-mated file print minutiae and other sample points on each file print pseudo-ridge with the search print direction field. This comparison is performed in the following manner. For each feature point (in this case each non-mated minutiae and sample point) associated with the file print image, find a correspondent point on the search print direction field. The block-based direction around the search point can be calculated to avoid noisy directions at one point. This direction is compared with the file feature point's direction. If they are within a predetermined tolerance determined by experiments and the quality of both points exceeds the quality measure, the feature point on the file print is said to have a match on the search print. Based on the additional matched points, a score is computed based on these matched points using the following equation (1):

$${S}_{p} = \frac{1}{N} {\sum }_{i = 1}^{N} {q}_{si} {q}_{fi} f ( {x}_{si} , {y}_{si} , {x}_{fi} , {y}_{fi} , \vert {θ}_{si} - {θ}_{fi} \vert , \vert {κ}_{si} - {κ}_{fi} \vert ) \qquad ( 1 )$$

where Sₚ is the total point matching score based on, N, points including sample ridge points and non-mated minutiae from the file print. The subscript s indicates search print, f indicates file print, and i indicates the ith point. x and y are the coordinates of a point. θ is the direction at the point, and K is the curvature at the point. The similarity between two points is measured by a function ƒ( ) and weighted by the quality q of the two points. ƒ( ) is selected in a way such that the more similar two points are, the higher the score Sₚ.

Next, the pseudo-ridges of the search and file prints are compared and a pseudo-ridge matching score computed, at step 816. In essence, if all or most of the sample points of a pseudo-ridge are found to have a match using the above procedure, a curve is fitted to the correspondent matched point set on search print image. If the fitted curve on the search print image is similar enough to the pseudo-ridge on the file print image, the pseudo-ridge on the file print image is considered to have a match on the search print image. The similarity between the pseudo-ridge and fitted curve is calculated by comparing the curvature on fixed-interval points on both curves. A pseudo-ridge matching score, Sᵣ, indicating the similarity between all matched pseudo-ridges can be computed using the following exemplary equation (2):

$${S}_{r} = \frac{1}{M} {\sum }_{i = 1}^{M} {\sum }_{j = 1}^{{N}_{i} - 1} {\overline{q}}_{sj} {\overline{q}}_{fj} g ( \vert {x}_{s ( j + 1 )}^{′} - {x}_{f ( j + 1 )} \vert , \vert {y}_{s ( j + 1 )}^{′} - {y}_{f ( j + 1 )} \vert ) . \qquad ( 2 )$$

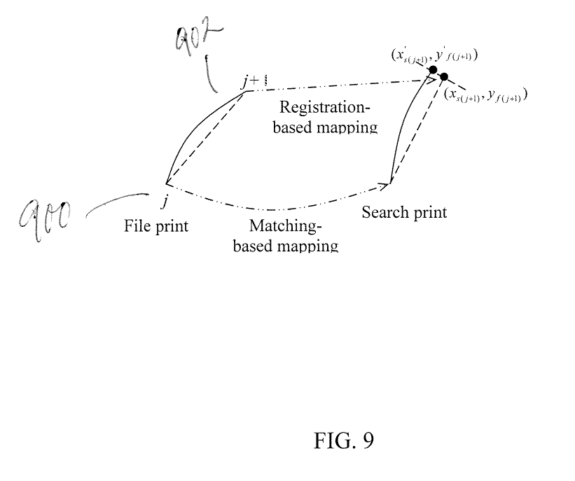

FIG. 9 can be used to help illustrate how equation (2) works to compute the pseudo-ridge matching score. More particularly, for each matched point j (900) and its nearest neighboring matched point (j+1) (902) on the file print pseudo-ridge, these points are projected onto the search print image in different ways. The jth point is projected to the search print's matched point. The (j+1)th point, however, is not projected to its search print matched point. Instead, the j+1)th point is projected rigidly onto the search print according to the registration relation (translation, rotation) between search and file print. The projected (j+1)th point is denoted by (xₛ₍ⱼ₊₁₎,y_{f(j+1)}) in FIG. 9. Then trace a sub-pseudo-ridge starting from the projected jth point toward the projected (j+1)th point on the search print. A virtual line is found at the projected (j+1)th point which is perpendicular to the line segment between the projected jth and (j+1)th points. The tracing of the sub-pseudo-ridge will stop when it crosses this virtual line, the crossing point is denoted as (xₛ₍ⱼ₊₁₎, Y_{f(j+1)}) in FIG. 9.

After finding the crossing point, the score associated with matched point j is calculated as q̅ₛⱼ q̅_{fj}g(|x′ₛ₍ⱼ₊₁₎−x_{f(j+1)}|,|y′ₛ₍ⱼ₊₁₎−y_{f(j+1)}|), where q̅ₛⱼ and q̅_{fj} is the average quality between point j and (j+1) on the sub-ridge of file print and search print, respectively. For Nᵢ matched points, Nᵢ-1 sub-ridges are counted and accumulated to obtain the score of one pseudo-ridge matching. Finally, M pseudo-ridge matching scores are accumulated to obtain the overall pseudo-ridge matching score Sᵣ. Here the result of equation (1) is used to determine whether or not the majority of the sampling points on a pseudo-ridge of one print image have matching sampling points on the corresponding pseudo-ridge of the other print image. If this is true, a curve is fitted to the correspondent matching point set, which is assumed to be the pseudo-ridge of the other print, and equation (2) is used to determine the pseudo-ridge score.

Using the set of mated minutiae obtained above, a minutiae matching score is calculated (step 818) using any suitable minutiae matching process and represents the minutiae matching score associated with the global feature alignment.

To implement the right branch of method 800, a separate minutiae matching based solely on a minutiae matcher without principle axis involved is performed, again using any suitable minutiae matching process. During this process, the search and file prints are aligned (step 808) solely on the minutiae. This minutiae matcher process outputs a corresponding set of mated minutiae and minutiae matching score (step 812). The pseudo-ridge matching score for this minutiae-based alignment is determined in the same manner above with respect to the global feature based alignment using equations (1) and (2).

As stated above, the left branch of method 800 provides one pseudo-ridge matching score and one minutiae matching score, and the right branch of method 800 also provides one pseudo-ridge matching score and one minutiae matching score. These four score can be “fused” or combined (step 824) using the following exemplary decision logic. In each decision logic “case” described below, the final score is S₄ and the input scores are Sₚᵣ, Sₚᵣₘ, Sₘ and Sₘₚᵣ, where Sₚᵣ denotes the score obtained from pseudo-ridge matching using global registration (alignment), Sₚᵣₘ denotes the associated minutiae matching score obtained using global registration, Sₘ denotes the independent minutiae matching score and Sₘₚᵣ denotes the associated pseudo-ridge matching score for minutiae alignment. In general, the decision logic in six different scenarios respectfully compares the four matching scores to four thresholds Tₚᵣ, Tₚᵣₘ, Tₘ, Tₘₚᵣ and selecting one of the scores as the combined score. The four thresholds can be determined offline experimentally from relevant databases. The six cases are as follows.

Case 1: Both methods yielded same registration. So the maximum of the following two matching scores is selected:

If Sₚᵣ>Tₚᵣ, Sₚᵣₘ>Tₚᵣₘ, Sₘ>Tₘ, Sₘₚᵣ>Tₘₚᵣ, S₄=max(Sₚᵣₘ, Sₘ)

If Sₚᵣ>Tₚᵣ, Sₚᵣₘ,<Tₚᵣₘ, Sₘ<Tₘ, Sₘₚᵣ>Tₘₚᵣ, S₄=max(Sₚᵣₘ, Sₘ)

Case 2: Global based registration is better than minutiae registration since global based registration yields a better pseudo ridge matching score or minutiae based registration yields inconsistent results between minutia matching score and pseudo ridge matching score. So, the global registration minutiae matching score is selected:

If Sₚᵣ>Tₚᵣ, Sₚᵣₘ>Tₚᵣₘ, Sₘ>Tₘ, Sₘₚᵣ<Tₘₚᵣ, S₄=Sₚᵣₘ

If Sₚᵣ>Tₚᵣ, Sₚᵣₘ>Tₚᵣₘ, Sₘ<Tₘ, Sₘₚᵣ>Tₘₚᵣ, S₄=Sₚᵣₘ

If Sₚᵣ>Tₚᵣ, Sₚᵣₘ>Tₚᵣₘ, Sₘ<Tₘ, Sₘₚᵣ<Tₘₚᵣ, S₄=Sₚᵣₘ

Case 3: Minutia based registration is better than global based registration since minutiae based registration yields a better pseudo ridge matching or global based registration yields inconsistent results between global minutiae matching score and pseudo ridge matching score. So, the minutiae matching score from the right branch is selected:

If Sₚᵣ>Tₚᵣ, Sₚᵣₘ<Tₚᵣₘ, Sₘ>Tₘ, Sₘₚᵣ>Tₘₚᵣ, S₄=Sₘ

If Sₚᵣ<Tₚᵣ, Sₚᵣₘ<Tₚᵣₘ, Sₘ>Tₘ, Sₘₚᵣ>Tₘₚᵣ, S₄=Sₘ

If Sₚᵣ<Tₚᵣ, Sₚᵣₘ>Tₚᵣₘ, Sₘ>Tₘ, Sₘₚᵣ>Tₘₚᵣ, S₄=Sₘ

Case 4: Both registration methods yields low pseudo ridge matching scores, which indicates that both of the mated minutiae are not reliable. Thus, the minimum of two minutiae matching score or another score is selected.

If Sₚᵣ<Tₚᵣ, Sₚᵣₘ>Tₚᵣₘ, Sₘ<Tₘ, Sₘₚᵣ<Tₘₚᵣ, S₄=min(Sₚᵣₘ, Sₘ)

If Sₚᵣ<Tₚᵣ, Sₚᵣₘ<Tₚᵣₘ, Sₘ<Tₘ, Sₘₚᵣ<Tₘₚᵣ, S₄=min(Sₚᵣₘ, Sₘ)

If Sₚᵣ<Tₚᵣ, Sₚᵣₘ>Tₚᵣₘ, Sₘ>Tₘ, Sₘₚᵣ<Tₘₚᵣ, S₄=min(Sₚᵣₘ, Sₘ)

If Sₚᵣ<Tₚᵣ, Sₚᵣₘ<Tₚᵣₘ, Sₘ>Tₘ, Sₘₚᵣ<Tₘₚᵣ, S₄=min(Sₚᵣₘ, Sₘ)

Case 5: Global registration yields a better pseudo ridge matching score, which indicates that the registration is more reliable. So the global registration based minutia matching score is selected.

If Sₚᵣ>Tₚᵣ, Sₚᵣₘ<Tₚᵣₘ, Sₘ>Tₘ, Sₘₚᵣ<Tₘₚᵣ, S₄=Sₚᵣₘ

If Sₚᵣ>Tₚᵣ, Sₚᵣₘ<Tₚᵣₘ, Sₘ<Tₘ, Sₘₚᵣ<Tₘₚᵣ, S₄=Sₚᵣₘ

Case 6: Minutiae registration yields a better pseudo ridge matching score, which indicates that the registration is more reliable. So the minutia registration based minutia matching score is selected.

If Sₚᵣ<Tₚᵣ, Sₚᵣₘ<Tₚᵣₘ, Sₘ<Tₘ, Sₘₚᵣ>Tₘₚᵣ, S₄=Sₘ

If Sₚᵣ<Tₚᵣ, Sₚᵣₘ>Tₚᵣₘ, Sₘ<Tₘ, Sₘₚᵣ>Tₘₚᵣ, S₄=Sₘ

From the above decision logic, we can see that the problem can be solved as a pattern classification method, wherein the input to the decision system is a vector (Sₚᵣ, Sₚᵣₘ, Sₘ, Sₘₚᵣ), and output of the system is four states/classes. The class 1, 2, 3 and 4 of the system/classifier represents one of the four possible state outputs for S₄: Sₘ, Sₚᵣₘ, max(Sₚᵣₘ, Sₘ), and min(Sₚᵣₘ, Sₘ) respectively. A parametric or non-parametric method can be used to design such a classifier. For example, neural networks can be used to learn the association between the input and output.

The above description of method 800 was directed to the example where the two fingerprints were of the plain arch type. Modified versions of this process, however, can be implemented as follows. For example, where the search and file print images share common registration points, e.g., core(s) and/or delta(a), the only difference in the process 800 from the plain arch type example is how the global registration is performed in step 814, wherein in this case the two fingerprint images are aligned based on the core(s) and/or delta(s). This can be performed by generating a common coordinate system for both the search and file print images using a registration point and its principle axes. Where cores exist in both print images, align the two fingerprint based the core. Where delta exists, align the two print images based on three delta angles for each print. Then determine the set of mated minutiae pairs based on the alignment. The different alignments can be verified against each other and the alignment yielding highest matching scores selected as the final alignment.

In another scenario, the search and file print images have no common registration points (core/delta) and no common axis. In this situation, only the right branch of method 800 is implemented and the two resulting scores are fused using the following equation (3):

S₂=h(Sₚᵣ)Sₘ (3)

where Sₚᵣ is the pseudo-ridge matching score. h( ) is a monotonically increasing function between 0 and 1, and Sₘ is the minutia matching score.

Furthermore as mentioned above method 800 can provide a set of mated minutiae to a secondary matcher at step 822. In one embodiment, the set so provided corresponds to the higher of the two minutiae matcher scores Sₚᵣₘ and Sₘ when both the left and right branches are implemented or corresponds to Sₘ in the case above when only the right branch is implemented.

The above-described embodiments provide for a novel mechanism for fingerprint verification, for instance. With the extracted pseudo-ridge features, orthogonal information is used to enhance fingerprint matching, thereby enabling greatly improved matching accuracy.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for comparing a search print image comprising a first plurality of minutiae to a file print image comprising a second plurality of minutiae, the method comprising the steps of:
aligning the search and file print images based on at least one parameter;
obtaining the first and second plurality of minutiae, a first plurality of pseudo-ridges generated from a first direction field of the search print image and a second plurality of pseudo-ridges generated from a second direction field of the file print image;
for each aligning of the search and file print images,
comparing the first and second plurality of pseudo-ridges and generating a pseudo-ridge score, and
determining a set of mated minutiae between the first and second plurality of minutiae and a corresponding minutiae matching score; and
providing, based on the pseudo-ridge and minutiae matching scores, an output that indicates a level of similarity between the search and file print images.

2. The method of claim 1, wherein the search and file prints images are one of fingerprint images and palm print images.

3. The method of claim 1, wherein the output comprises at least one of a set of mated minutiae provided to a secondary matcher stage and a combined score based on the pseudo-ridge and minutiae matching scores that were determined.

4. The method of claim 3 further comprising the step of comparing each of the determined pseudo-ridge and minutiae matching scores to a corresponding threshold to generate the combined score.

5. The method of claim 4 further comprising the step of selecting a score from the determined pseudo-ridge and minutiae matching scores based on the step of comparing the scores to the corresponding thresholds, wherein the combined score comprises the selected score.

6. The method of claim 5, wherein the determined pseudo-ridge and minutiae matching scores comprises:
a first pseudo-ridge score and a first minutiae matching score determined from aligning the search and file print images based on the first and second plurality minutiae; and
a second pseudo-ridge score and a second minutiae matching score determined from aligning the search and file print images based on a first set of global features identified from the search print image and a second set of global features identified from the file print image; and
the combined score is selected from the four generated pseudo-ridge and minutiae matching scores.

7. The method of claim 3 further comprising the step of calculating the combined score based on a function of the determined pseudo-ridge and minutiae matching scores.

8. The method of claim 7, wherein the determined pseudo-ridge and minutiae matching scores comprises one pseudo ridge score and one minutiae matching score.

9. The method of claim 3, wherein a first set of mated minutiae and corresponding first minutiae matching score is determined from a first aligning of the search and file print images based on a first parameter and at least a second set of mated minutiae and corresponding second minutiae matching score is determined from a second aligning of the search and file print images based on a second different parameter, the method further comprising the step of:
selecting a larger of the first and the at least a second minutiae matching scores, wherein the set of mated minutiae provided to the secondary matching stage corresponds to the selected larger score.

10. The method of claim 9, wherein:
the first aligning is based on the first and second plurality minutiae; and
the second aligning is based on a first set of global features identified from the search print image and a second set of global features identified from the file print image.

11. The method of claim 1, wherein aligning the search and file print images based on at least one parameter comprises:
aligning the search and file print images based on the first and second plurality minutiae; and
aligning the search and file print images based on a first set of global features identified from the search print image and a second set of global features identified from the file print image.

12. The method of claim 11, wherein the first and second set of global features each comprise at least one of a core, a delta, an arch, a loop and a whorl.

13. The method of claim 11, wherein:
a first pseudo-ridge score and a first minutiae matching score is generated from the aligning based on the first and second plurality of minutiae;
a second pseudo-ridge score and a second minutiae matching score is generated from the aligning based on the first and second set of global features; and
the output is based on the four pseudo-ridge and minutiae matching scores.

14. Apparatus for comparing a search print image comprising a first plurality of minutiae to a file print image comprising a second plurality of minutiae, the apparatus comprising:
an interface receiving the search and file print images; and
a processing device coupled to the interface, the processing device,
aligning the search and file print images based on at least one parameter;
obtaining the first and second plurality of minutiae, a first plurality of pseudo-ridges generated from a first direction field of the search print image and a second plurality of pseudo-ridges generated from a second direction field of the file print image;
for each aligning of the search and file print images,
comparing the first and second plurality of pseudo-ridges and generating a pseudo-ridge score, and
determining a set of mated minutiae between the first and second plurality of minutiae and a corresponding minutiae matching score; and
providing, based on the pseudo-ridge and minutiae matching scores, an output that indicates a level of similarity between the search and file print images.

15. The apparatus of claim 14, wherein the apparatus is included in an Automatic Fingerprint Identification System (AFIS).

16. The apparatus of claim 14, wherein the processing device comprises at least one of: a microprocessor executing code; an Application Specific Integrated Circuit (ASIC), a field programmable gate array (FPGA) and a state machine.

17. A computer-readable storage element having computer readable code stored thereon for programming a computer to perform a method for comparing a search fingerprint image comprising a first plurality of minutiae to a file fingerprint image comprising a second plurality of minutiae, the method comprising the steps of:
aligning the search and file fingerprint images based on at least one parameter;
obtaining the first and second plurality of minutiae, a first plurality of pseudo-ridges generated from a direction field of the search fingerprint image and a second plurality of pseudo-ridges generated from a direction field of the file fingerprint image;
for each aligning of the search and file fingerprint images,
comparing the first and second plurality of pseudo-ridges and generating a pseudo-ridge score, and
determining a set of mated minutiae between the first and second plurality of minutiae and a corresponding minutiae matching score; and
providing, based on the pseudo-ridge and minutiae matching scores, an output that indicates a level of similarity between the search and file fingerprint images.

18. The computer-readable storage medium of claim 17, wherein the computer readable storage medium comprises at least one of a hard disk, a CD-ROM, an optical storage device and a magnetic storage device.
